(19) United States
(12) Patent Application Publication
(10) Pub. No.: US 2008/0019382 A1
(43) Pub. Date: Jan. 24, 2008

(54) Telecommunications switching

(75) Inventors: Bradley John Wainwright, Kew (GB); Michael Joseph Cooper, Farnham (GB); Mick Mulvey, Ipswich (GB); James Peter Patterson, East Finchley (GB); Peter Joseph Brucia, Fairfield, CT (US); Dan Hubscher, South Orange, NJ (US); Carl Everard Hunte, Langhorne, PA (US); Mitchell Garfield McGuire, Bridgewater, NJ (US); Richard Roy Snape, Morristown, NJ (US)

Correspondence Address: NIXON & VANDERHYE, PC, 901 NORTH GLEBE ROAD, 11TH FLOOR, ARLINGTON, VA, 22203, US

(73) Assignee: BRITISH TELECOMMUNICATIONS public limited company

(21) Appl. No.: 11/489,719

(22) Filed: Jul. 20, 2006

(51) Int. Cl. H04L 12/56

(52) U.S. Cl. 370/401; 370/392; 370/235

(57) ABSTRACT

A virtual private data network is overlain on an internet connection to allow prioritisation of connection between two or more specified terminations over a switched network, thereby minimising latency in the system. Data to be transmitted between the specified terminations is identified by a weighting prefix and its routing is prioritised over other data for the same destination termination.

This application is one of two filed on the same date, and has applicant's reference B31148.

This invention relates to telecommunications systems, and in particular to the provision of dedicated connections between defined points.

It is now possible to connect almost any telecommunications device to any other using conventional switched networks (circuit switched or packet switched), but for some applications the problems of contention for bandwidth with other subscribers, and latency caused by the switching functions themselves, mean that point-to-point links still have uses for specialised applications. In particular, for many time-critical applications, minimising network-induced latency is a priority. A dedicated point-to-point circuit will provide such a service, but is expensive to provide as it requires dedicated infrastructure to be installed over the entire length of the link, and there are few synergies available to reduce the cost of installing several such links.

The present invention provides a way of configuring a switch such that one or more dedicated virtual point-to-point links can be provided over the network controlled by the switch. In essence, capacity is prioritised in the switch for each such point-to-point link, which is routed so as to minimise latency.

According to a first aspect of the present invention, there is provided a communications system having means for prioritising connection between at least two specified terminations over a switched network, to operate a virtual private connection, the system comprising means for identifying data to be transmitted between the specified terminations, means for generating data header information for such data, and means for controlling the routing of said data over predetermined connections in the network, said data being prioritised over other data for the same destination termination such that data latency is minimised.

According to another aspect of the present invention, there is provided a method of establishing a communications link between at least two specified terminations over a switched network, to operate as a virtual private connection, wherein data to be transmitted between the specified terminations is identified, data header information is generated for such data, and the routing of data having such header information is controlled to be made over predetermined connections in the network, said data being prioritised over other data for the same destination termination such that data latency is minimised.

In a preferred embodiment, a weighting is applied to data for transmission between the specified terminations, wherein the data takes precedence over data not carrying the weighting. The routing of said data may be controlled to be routed over a primary connection and at least one secondary connection, the secondary connection being controlled to deliver the data in the event of failure of the primary connection. This may be achieved by having an intermediate weighting for the secondary connection.

If it is likely that several terminations may all require access to data from one termination at the same time, the same data may be transmitted over a plurality of physical circuits to, or from, one or more of the terminations, the separate circuits carrying the data from, or to, different terminations.

The system may be used for individual users to access data on demand, or may also be used to allow a single information provider to supply data to several subscribers simultaneously. In the latter case, the connections may be arranged to be one-way, in accordance with our co-pending application entitled Telecommunication Multicast System, filed on the same date as the present application, with reference B31149. This prevents the multicast connection being used to transmit data between the destination terminals in an uncontrolled manner.

A number of embodiments of the invention will now be described, with reference to the drawings, in which

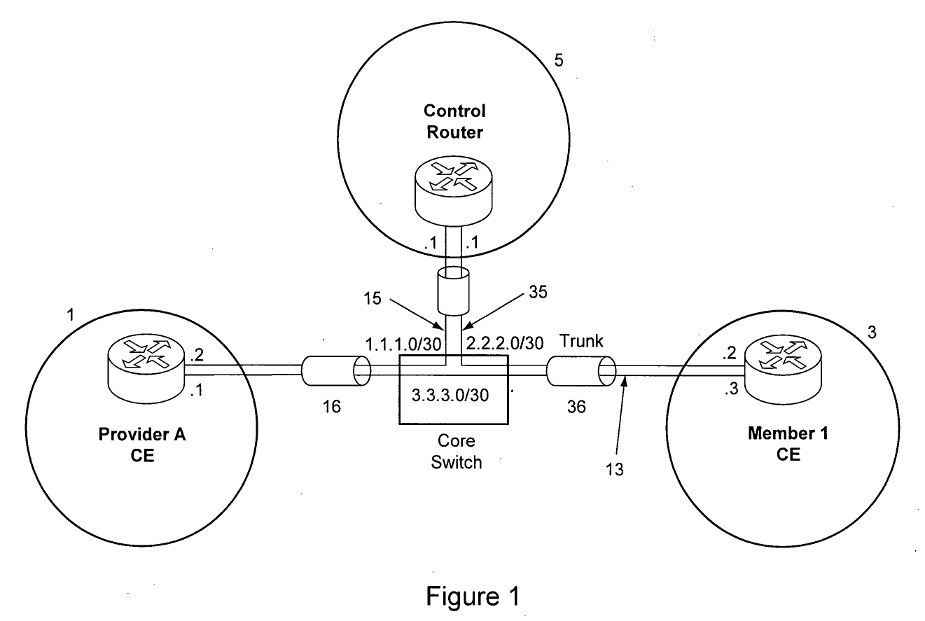

FIG. 1 illustrates the control plane of a simplified embodiment according to the invention, for one-to-one provision:

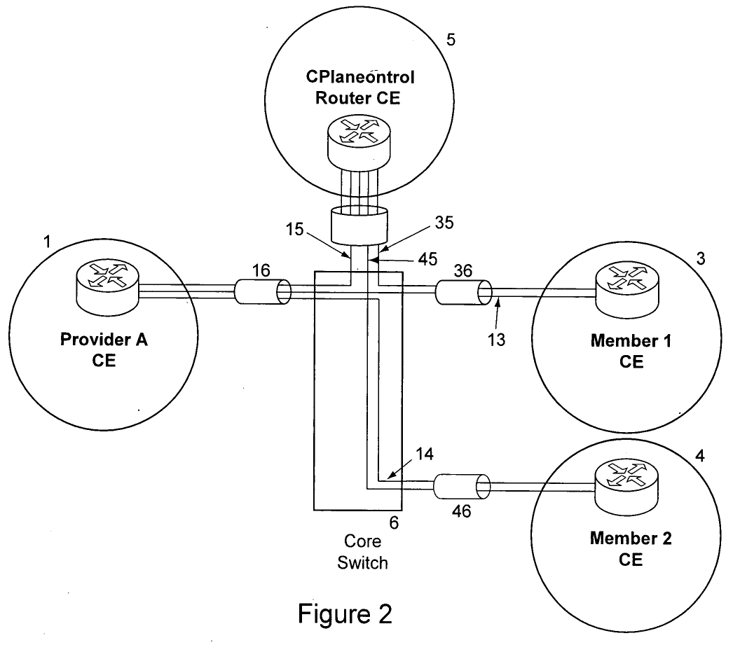

FIG. 2 extends this principle to a one-to-many provision;

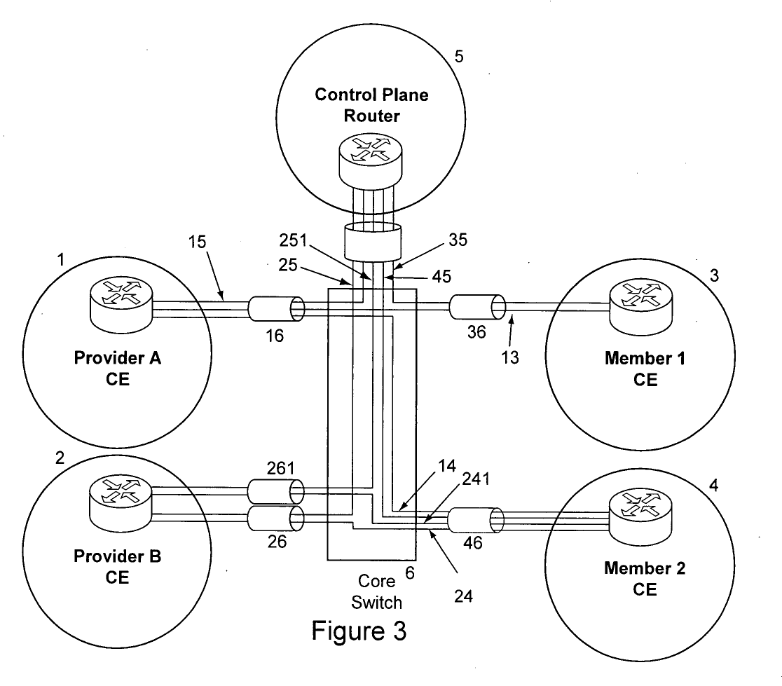

FIG. 3 further extends this principle to a many-to-many provision;

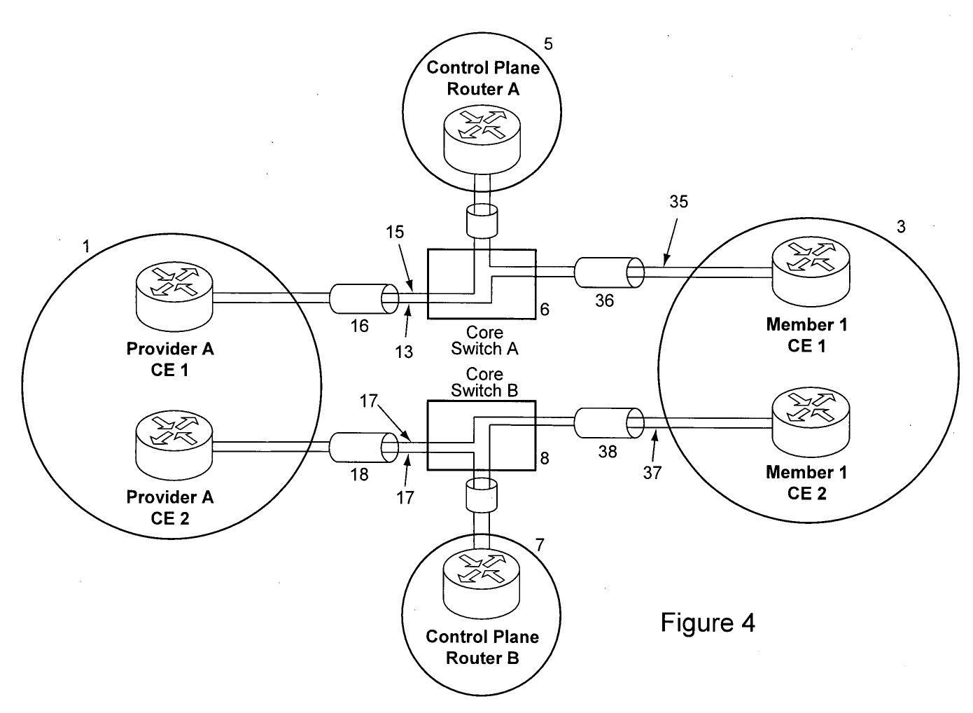

FIG. 4 shows a further embodiment, having resilient provision.

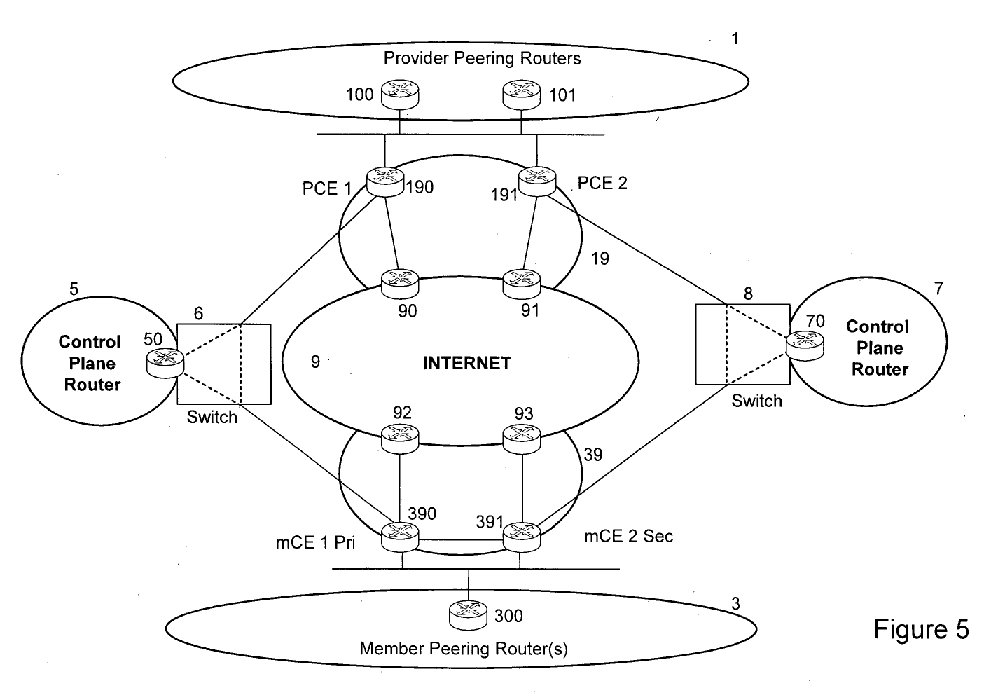

FIG. 5 shows how the functionality of the earlier embodiments may be overlain on a conventional network

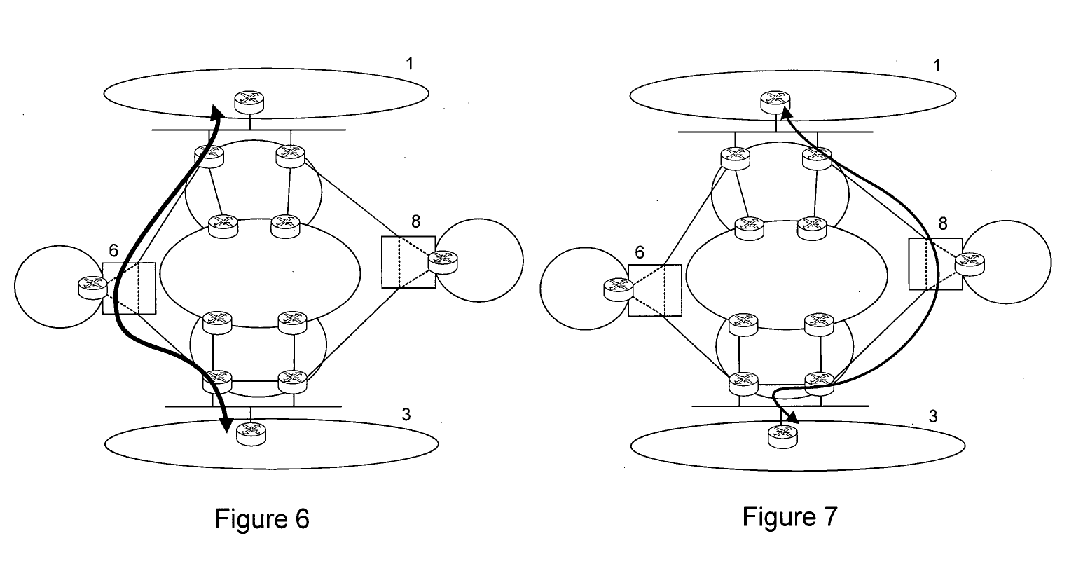

FIG. 6 illustrates the flow of data in the system of FIG. 5 in a normal situation

FIG. 7 illustrates the flow of data in the system of FIG. 5 in an abnormal situation.

The embodiments provide delivery of data using dedicated point-to-point VLANs, independent from the host system, but in such a way that the users can simultaneously access the host network conventionally for connections without point-to-point connectivity, and maintaining the standard paradigms, so maintaining routing policies into the customer domain. In the event of failure of the dedicated VLAN, the users may recover feed from the conventional connection.

FIG. 1 illustrates the control plane of a simplified embodiment according to the invention. For the purposes of illustration the two terminations 1, 2 are described as “information provider” and “subscriber” respectively—in general the subscriber 2 addresses requests for information to the provider 1, and the requested information is returned to the subscriber 2 in response.

The provider 1 and subscriber 2 are both connected by way of trunk connections 16, 36 to a switch 6, the connections being under the control of a control plane router 5. The Core switch 6 provides the switching capability that delivers both the infrastructure and service connectivity. The control plane router 5 provides a security enforcement layer in terms of routing policy control. The control plane router 5 is connected, in the control plane, to the provider 1 and subscriber 3 over respective point to point VLANs 15, 35 running under eBGP (external border gateway protocol).

Provider Prefixes are advertised to the Subscribing Member 3 via the Control Plane Router 5. On reception at the Control Plane Router 5, the Prefixes are assigned standard BGP Community markings to indicate, amongst other things, the Provider 1 to which they belong. At the Subscriber equipments an in-bound Route-map is used to set the next-hop for this prefix as the IP address of the Provider end of the Traffic Forwarding VLAN. For example, in FIG. 1 the next hop would be set to 3.3.3.1. (Note that the IP addresses used are for ease of representation and are not representative) The same Prefix advertisement and next-hop association is used for Member-to-Provider Prefix advertisement.

FIG. 2 extends this principle to a Provider 1 delivering to two Members (subscribers) 3, 4. Each Member 3, 4 has a dedicated Point-to-Point VLAN connection 35, 45 to the Control Plane Router 5. An eBGP Peer within this VLAN delivers to each member the Prefixes to which the member subscribes. The Member CE's Inbound BGP Route-map attached to the Control Plane eBGP Peer will set the next-hop appropriate to the Traffic Forwarding VLAN to the Provider 1 based on the standard BGP Community Tags.

In general a single physical Connection 16 from a Provider 1 will comprise a single eBGP Peering VLAN 15 to the Control Plane Router 5, together with a number of Traffic forwarding VLANs 13, 14 equal to the number of Subscribing Member Sites 3, 4. Where bandwidths dictate a Provider may have need for more than one physical connection 16. If this is the case, Member VLANs 3, 4 will be spread across the Physical connections. At the member site, the BGP Community tags will be used to correctly map the Member to the correct traffic Forwarding VLAN for that Provider's Service connection.

FIG. 3 shows the scheme extended to multiple Providers 1, 2 as well as multiple Members 3, 4. In the simple case shown, one Member 4 subscribes to Services from both Providers 1,2. Another B Member 3 subscribes to Services only from one Provider 1. Because of bandwidth demands, the second Provider 2 has Members 4 spread across two physical circuits 26, 261 from the Core 6 to the provider's head-end.

Each Physical circuit 16, 26, 261 from a Provider's site has within it a single control-Plane-Peer eBGP Routing VLAN. This Peer delivers Prefix advertisements for the total of the services being delivered by all of the aggregate VLANs sharing the same physical connection from the Provider site. Inbound prefix filtering and community marking is performed at the Control Plane Router 5. The prefix filter provides a security control ensuring that a given site, (member or provider), only advertises authorised ranges.

Outbound community based filtering allows a Member 3, 4 to selectively choose either all Provider Prefixes or a sub-set of service specific Prefixes from the Provider.

Prefixes are assigned a set of communities on the Control Plane router 5 via an inbound Route-map on the BGP Peer from the Providers' Customer equipments 1, 2. In-bound prefixes from the Provider Customer equipment 1, 2 are only allowed into the Control Plane Router 5 if they come from the known Range of Prefixes expected from that Member 1, 2.

In a variant embodiment shown in FIG. 4, resilience is provided by the provision of two diverse connections to two separate switch points of presence (POPs) 6, 8. In FIG. 4, components are labelled as in FIG. 1, with the primary router and switch numbered 5, 6 as before, the duplicate router and switch labelled as 7, 8 respectively and other components in the duplicate connection numbered correspondingly. As a general principle one of the available Traffic Forwarding VLANs and associated Control-Plane VLAN between any Provider 1 and Member 3 is designated the Primary Connection 13. A second VLAN 8 and associated control plane 7 is provided as a secondary connection 131. The arrangement at both Member and Provider sites 1, 2 may be varied to allow the system to be overlaid on existing conventional implementations at any given site.

FIG. 5 shows the connectivity of the embodiment of FIG. 4 overlaid on existing Internet Access. The provider 1 is shown as having duplicate peering routers 100, 101, both of which can access local access gateways 190, 191 which give access to the internet 9 through access gateways 90, 91. Similarly, the subscriber 3 has a peering router 30, which is coupled to local access gateways 390, 391 which again are connected to internet gateways 92, 93. The local access Gateways 190, 191, 390, 391 are the interfaces between the Points of presence (POP's) 6, 8 of the virtual LAN system of the invention and those of the conventional connections. Normal internet access is therefore available to the users of the network, and the invention can be overlaid on the existing infrastructure by the provision of main and duplicate control plane routers 5, 7, causing the local access routers to route data between the provider 1 and member 3 (and vice versa) through the primary or secondary switches 6, 8. The conventional internet 9 draws traffic from the Member network 30 to the Primary CE 290, even in the event of a Primary link failure, to ensure that NAT persistency is maintained during failover. This implementation of the present invention takes into account both the retention of this feature and the need to preferentially route traffic over the dedicated VLAN connection 6, 8 for designated provider prefixes. In general this requires the Primary leg 6 to be aligned with the Primary conventional connection 190, 390 at each end.

Generally the selection of the dedicated connection will be performed based on longest match prefixes, since the intention is to advertise more explicit prefixes over the eBGP connections than are advertised over the conventional connection. However, to cater for instances where identical prefixes are delivered from the two sources, having the same prefix length, then the following design provides relevant design aspects.

In general the conventional connections maintain a Primary/Secondary relationship, together with NAT persistence across the two Member equipments using a combination of the route-reflection from Secondary to Primary CE, and Weight attribute. The conventional design allows for reflection of Provider prefixes to the Primary CE from the Secondary CE, with Provider Prefixes being preferred from the Primary CE WAN interface due to a high weight (1000) being applied to these prefixes. By setting of the weight attribute to 2000 on Prefixes arriving from the Control Plane Router 5 for the dedicated link, it can be arranged that these prefixes are always preferred over any conventional Prefixes arriving over the conventional link 92. Similarly, setting of Weight 1500 on Prefixes arriving over the Secondary connection 7, 8 ensures that again such Prefixes are preferred to prefixes arriving over the conventional Primary Link 92, 93 but not over the dedicated primary ink 5, 6. If both Primary & Secondary dedicated Links fail then the CE's will revert back to routing via the conventional Primary/Secondary feeds 390, 391 as in normal operation, provided that the same prefixes or associated aggregate prefixes have been advertised over the conventional connections. The conventional connection, being a switched network having several possible routings, will be more robust than the virtual fixed link, but because the connections are not dedicated to the point to point link the transmission will be more subject to delays through longer routings and contention for capacity than on the dedicated connection.

The resulting Traffic flow over the system of FIG. 5 between Member 3 and Provider 1 in normal operation is shown in FIG. 6, whilst in the event of a failure of the Primary Link 6 the resulting traffic flow is shown in FIG. 7.

Where no iBGP Link exists at a Provider head-end and BGP Routing is delivered into the Provider, then notification to the Provider that the Primary Connection has failed is reliant on delivery of explict prefixes for the affected Members into the Provider. Where this is not possible, an iBGP link may be provided between the Provider Head-end CE's or, alternatively, delivery of accesses from both Core POPs to each of the head-end CE's.

Typical conventional implementations of the BGP Minimum Route Advertisement Interval Timer is on a per BGP Peer basis, and not by destination Prefix & Peer. The net effect of this is that, left to default settings, competing Prefix advertisements within both the Control Plane Routers and within the edge CE's can hold back route withdrawals for up to 30 seconds. In order to align with the iBGP default timer, the eBGP Peers should have their Timer reduced to 5 seconds. In the absence of competing prefix withdrawals, this will allow failover on a dedicated virtual LAN connection to meet a convergence target of about 10 seconds.

It is important that burst profiles are dimensioned such that they do not incur queuing penalties within the L2 domain. This is necessary for designing a QOS policer that never drops, and also for understanding any temporal queuing points in the layer 2 switch.

1. A communications system having means for prioritising connection between at least two specified terminations over a switched network, to operate a virtual private connection, the system comprising means for identifying data to be transmitted between the specified terminations, means for generating data header information for such data, and means for controlling the routing of said data over predetermined connections in the network, said data being prioritised over other data for the same destination termination such that data latency is minimised.

2. A communications system according to claim 1, comprising means to apply a data weighting to data for transmission between the specified terminations, wherein such data takes precedence over data not carrying the weighting.

3. A communications system according to claim 1, comprising means for controlling the routing of said data to be over a primary connection and at least one secondary connection, the secondary connection being controlled to deliver the data in the event of failure of the primary connection.

4. A communications system according to claim 1, comprising means for transmitting the same data over a plurality of separate physical circuits to, or from, one or more of the terminations, the separate circuits carrying the data from, or to, different terminations.

5. A communications system according to claim 1, arranged for multicast operation, wherein the connection to one of the terminations is arranged only to transmit data, and the connections to the other terminations are arranged only to receive data

6. A method of establishing a communications link between at least two specified terminations over a switched network, to operate as a virtual private connection, wherein data to be transmitted between the specified terminations is identified, data header information is generated for such data, and the routing of data having such header information is controlled to be made over predetermined connections in the network, said data being prioritised over other data for the same destination termination such that data latency is minimised.

7. A method according to claim 6, wherein a data weighting is applied to data for transmission between the specified terminations, wherein such data takes precedence over data not carrying the weighting.

8. A method according to claim 6, wherein the routing of said data is controlled to be routed over a primary connection and at least one secondary connection, the secondary connection being controlled to deliver the data in the event of failure of the primary connection.

9. A method according to claim 6, wherein the same data is transmitted over a plurality of physical circuits to, or from, one or more of the terminations, the separate circuits carrying the data from, or to, different terminations.

10. A method according to claim 6, wherein the connection to one of the terminations is arranged only to transmit data, and is arranged for multicast transmission to a plurality of other terminations arranged only to receive data
